(19) United States
(12) Patent Application Publication
(10) Pub. No.: US 2023/0246482 A1
(43) Pub. Date: Aug. 3, 2023

(54) CONTACTLESS POWER SUPPLY SYSTEM

(71) Applicant: TOYODA GOSEI CO., LTD., Kiyosu-shi (JP)

(72) Inventors: Yuki TOKUYAMA, Kiyosu-shi (JP); Shinichiro FUKI, Kiyosu-shi (JP); Atsushi SUGIHARA, Kiyosu-shi (JP)

(21) Appl. No.: 18/158,564

(22) Filed: Jan. 24, 2023

(30) Foreign Application Priority Data
Feb. 1, 2022 (JP) 2022-014257

(51) Int. Cl. H02J 50/00; H02J 50/12; H02J 50/40

(52) U.S. Cl. CPC H02J 50/005; H02J 50/12; H02J 50/402; H02J 50/20

(57) ABSTRACT

A contactless power supply system includes one or more power receiving devices, a power transmitting device, and a determining unit. The power receiving devices each include a transmitting unit and a power receiving unit. The power transmitting device includes a receiving unit and a power supplying unit. The determining unit is configured to determine, based on a prevention condition information that represents a prevention condition, whether the power receiving device that has transmitted the beacon signal satisfies the prevention condition. The power received by the power receiving device is prevented from increasing when the prevention condition is satisfied. The power supplying unit is configured to reduce power supply to the power receiving device that satisfies the prevention condition based on a determination result of the determining unit.

### BACKGROUND

### 1. Field

The present disclosure relates to a contactless power supply system.

### 2. Description of Related Art

Techniques related to contactless power supply using a power transfer signal are typical.

In a typical technique, a power receiving device transmits a beacon signal to a power transmitting device. The power transmitting device supplies power to the power receiving device based on the received beacon signal. The power receiving device may receive excessive power, for example, in a case in which the distance between the power transmitting device and the power receiving device is too short or in a case in which the direction in which the power transmitting device supplies power agrees with the orientation of the power receiving device.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a contactless power supply system includes one or more power receiving devices, a power transmitting device, and a determining unit. Each power receiving device includes a transmitting unit that is configured to transmit a beacon signal to the power transmitting device, and a power receiving unit that is configured to receive power from the power transmitting device by contactless power supply. The power transmitting device includes a receiving unit that is configured to receive the beacon signal from each power receiving device, and a power supplying unit that is configured to supply power to the power receiving devices by contactless power supply. The determining unit is configured to determine, based on a prevention condition information that represents a prevention condition, whether the power receiving device that has transmitted the beacon signal satisfies the prevention condition, the power received by the power receiving device being prevented from increasing when the prevention condition is satisfied. The power supplying unit is configured to reduce power supply to the power receiving device that satisfies the prevention condition based on a determination result of the determining unit.

Other features and aspects will be apparent from the following detailed description, the drawings, and the claims.

### BRIEF DESCRIPTION OF THE DRAWINGS

FIG. 1 is a diagram showing an overall configuration of a contactless power supply system.

FIG. 2 is a diagram showing one example of the configuration of the contactless power supply system.

FIG. 3 is a flowchart showing one example of a determination process.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

In this specification, “at least one of A and B” should be understood to mean “only A, only B, or both A and B.”

### Embodiment

A contactless power supply system 1 according to one embodiment will now be described with reference to the drawings.

[Overall Configuration of Contactless Power Supply System 1]

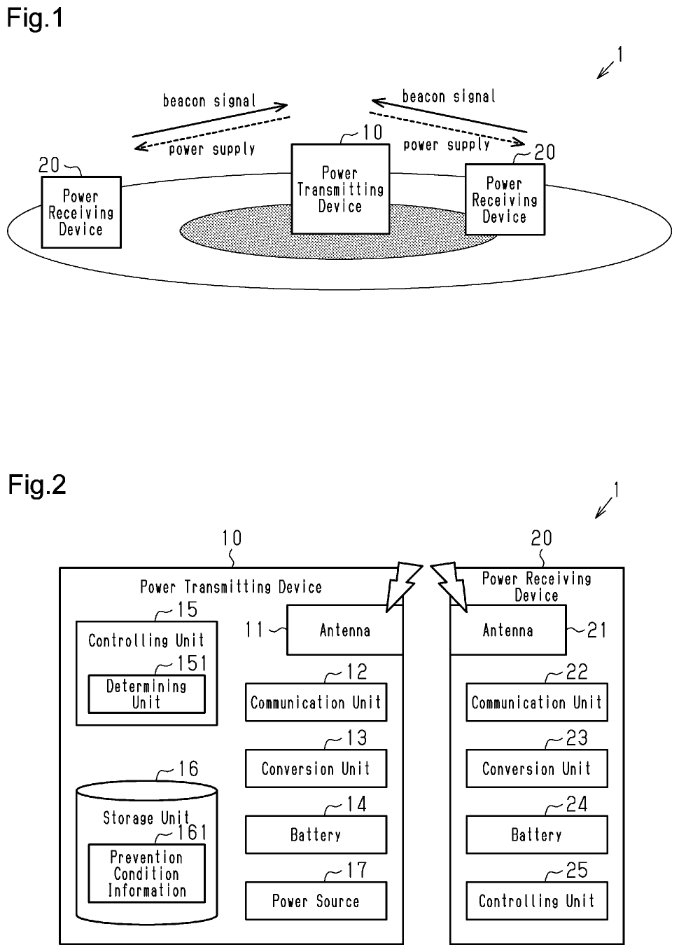

As shown in FIG. 1, the contactless power supply system 1 includes a power transmitting device 10, and power receiving devices 20. For example, the power transmitting device 10 supplies power to the power receiving devices 20 through contactless power supply using power transfer signals. Specifically, the contactless power supply system 1 wirelessly transfers power using a microwave method for contactless power supply. That is, the power transmitting device 10 and the power receiving devices 20 transmit and receive power transfer signals for contactless power supply between power receiving antennas of the power receiving devices 20 and the power transmitting antenna of the power transmitting device 10. The wireless power transfer method (contactless power transfer method) employed in this system is not limited to the microwave method, but may be an electromagnetic induction method, a magnetic field resonance method, an electric field resonance method, or a method using a laser. In the present embodiment, the transmission and reception of the power transfer signals are used for the contactless power supply. However, the wireless transmission and reception of the power transfer signals may be performed for purposes other than the contactless power supply.

Each power receiving device 20 receives a power transfer signal transmitted from the power transmitting device 10, and operates with the received power or charges its own battery with the received power.

In order to properly transmit a power transfer signal to each power receiving device 20, the power transmitting device 10 is required to properly set the phase of the power transfer signal based on the orientation of the power receiving device 20 with respect to the power transmitting device 10 and the distance to the power receiving device 20. Accordingly, the power receiving device 20 transmits a beacon signal to the power transmitting device 10 at specified time intervals. The power transmitting device 10 supplies power to the power receiving device 20 based on the phase change information of the beacon signal from the power receiving device 20.

The power receiving device 20 may receive excessive power, for example, in a case in which the distance between the power transmitting device 10 and the power receiving device 20 is too short or in a case in which the direction in which the power transmitting device 10 supplies power agrees with the orientation of the power receiving device 20.

The power transmitting device 10 of the present embodiment prevents the power receiving devices 20 from receiving excessive power. The configuration of the power transmitting device 10 and the configuration of the power receiving device 20 will now be described.

[Configuration of Power Transmitting Device 10]

As shown in FIG. 2, the power transmitting device 10 includes, for example, an antenna 11, a communication unit 12, a conversion unit 13, a battery 14, and a controlling unit 15, a storage unit 16, and a power source 17.

The antenna 11 is used for various types of communication with the power receiving devices 20. The antenna 11 is commonly used, for example, in communication related to power transfer signals, communication related to beacon signals, and information communication related to transmission and reception of various types of information. The antenna 11 includes, for example, an antenna array. The antenna 11 is an example of a power supplying unit. The antenna 11 transmitting power transfer signals to the power receiving devices 20 is an example of supplying power to the power receiving devices 20 by contactless power supply.

The communication unit 12 performs various types of control related to communication with the power receiving devices 20. The communication unit 12 controls, for example, the antenna 11 and receives beacon signals transmitted by the power receiving devices 20. The communication unit 12 may be circuitry including: 1) one or more processors that operate according to a computer program (software); 2) one or more dedicated hardware circuits (application specific integrated circuits: ASIC) that execute at least part of various processes; or 3) a combination thereof. The communication unit 12 controls the antenna 11 to transmit and receive various kinds of information to and from the power receiving devices 20. The information communication related to transmission and reception of various types of information is implemented by, for example, Bluetooth (registered trademark), Wi-Fi, or ZigBee (registered trademark). The communication unit 12 is an example of a receiving unit in a process of controlling the antenna 11 and receiving beacon signals from the power receiving devices 20.

When supplying power to a power receiving device 20, the conversion unit 13 converts power into a power transfer signal and transmits the power transfer signal via the antenna 11. The conversion unit 13 may convert power supplied from the power source 17 into a power transfer signal, or may convert power stored in the battery 14 (described below) into a power transfer signal. The power source 17 includes, for example, a power conversion circuit that converts power supplied from grid-connected power into power that can be used in the power transmitting device 10. The power source 17 is an example of a first power source.

The battery 14 stores power supplied from the power source 17. The power capacity of the battery 14 when fully charged is, for example, a power capacity capable of supplying sufficient power to the power receiving devices 20 in the contactless power supply system 1. The battery 14 is an example of a second power source.

The controlling unit 15 controls each unit included in the power transmitting device 10. The controlling unit 15 may include circuitry including a hardware processor such as a central processing unit (CPU) configured to execute programs (software). Some or all of the constituent elements of the circuitry may be implemented by hardware such as a large scale integration (LSI), an application specific integrated circuit (ASIC), a field- programmable gate array (FPGA), or a graphics processing unit (GPU), or may be implemented by cooperation of software and hardware. The programs may be stored in advance in the storage unit 16, which include a storage device (not shown) including a non-transitory storage medium such as a hard disk drive (HDD) or a flash memory included in the power transmitting device 10. For example, the controlling unit 15 adjusts the phase of the antenna 11 based on beacon signals received by the communication unit 12.

The storage unit 16 may be implemented by the various storage devices described above. Alternatively, the storage unit 16 may be implemented by an electrically erasable programmable read-only memory (EEPROM), a read-only memory (ROM), a random access memory (RAM), or the like. In addition to the above-described programs, the storage unit 16 stores prevention condition information 161. The prevention condition information 161 is information representing prevention conditions for preventing the power received by the power receiving device 20 from increasing.

In this example, a case will be described in which the prevention condition information 161 includes information representing two prevention conditions: a first prevention condition CC1 and a second prevention condition CC2. The first prevention condition CC1 represents a state in which the distance between the power transmitting device 10 and the power receiving device 20 that has transmitted a beacon signal is shorter than a specified distance. The second prevention condition CC2 represents a state in which the ratio of the power supplied by the power transmitting device 10 to the power receiving device 20 that has transmitted a beacon signal to the power received by the power receiving device 20 that has transmitted the beacon signal is greater than a specified threshold.

The controlling unit 15 includes, for example, a determining unit 151. The determining unit 151 may include circuitry including a hardware processor such as a central processing unit (CPU) configured to execute programs (software). The determining unit 151 determines whether the power receiving device 20 that has transmitted a beacon signal satisfies the prevention conditions based on the prevention conditions represented by the prevention condition information 161. The power transmitting device 10 reduces power supply to the power receiving device 20 that satisfies the prevention conditions based on the determination result of the determining unit 151. Specifically, when supplying power to the power receiving device 20 that satisfies the prevention conditions, the antenna 11 reduces power supply by reducing the number of antennas to be operated in the antenna array as compared to a case in which the antenna 11 supplies power to a power receiving device 20 that does not satisfy the prevention conditions.

[Configuration of Power Receiving Device 20]

The power receiving device 20 includes an antenna 21, a communication unit 22, a conversion unit 23, a battery 24, and a controlling unit 25.

The antenna 21 is used for various types of communication with the power transmitting device 10. The antenna 21 is commonly used, for example, in communication related to power transfer signals, communication related to beacon signals, and information communication related to transmission and reception of various types of information. The antenna 21 is an example of a power receiving unit. The antenna 21 receiving a power transfer signal transmitted by the power transmitting device 10 is an example of receiving power from the power transmitting device 10 by contactless power supply.

The communication unit 22 performs various types of control related to communication with the power transmitting device 10. The communication unit 22 controls, for example, the antenna 21 to transmit a beacon signal to the power transmitting device 10. The communication unit 22 controls the antenna 21 to transmit and receive various kinds of information to and from the power transmitting device 10. The communication unit 22 may be circuitry including: 1) one or more processors that operate according to a computer program (software); 2) one or more dedicated hardware circuits (application specific integrated circuits: ASIC) that execute at least part of various processes; or 3) a combination thereof. The communication unit 22 is an example of a transmitting unit in a process of controlling the antenna 21 and transmitting a beacon signal to the power transmitting device 10.

The conversion unit 23 converts the power transfer signal received by the antenna 21 into direct-current power. The battery 24 stores the direct-current power converted by the conversion unit 23. The power receiving device 20 operates by the power stored in the battery 24.

The controlling unit 25 controls each unit included in the power receiving device 20. The controlling unit 25 may include circuitry including a hardware processor such as a CPU configured to execute programs (software). Some or all of the constituent elements of the circuitry may be implemented by hardware such as an LSI, an ASIC, an FPGA, or a GPU, or may be implemented by cooperation of software and hardware. The programs may be stored in advance in a non-transitory storage medium such as an HDD or a flash memory included in the power receiving device 20. The controlling unit 15 instructs the communication unit 12 to transmit beacon signals to the power transmitting device 10, for example, at specified time intervals.

[Operation Flow]

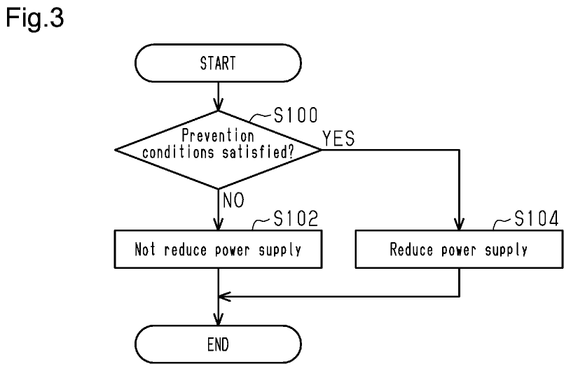

The process performed by the determining unit 151 will now be described with reference to FIG. 3. The process of the flowchart shown in FIG. 3 is repeatedly executed at specified time intervals, for example. The determining unit 151 first determines whether the power receiving device 20 that has transmitted the beacon signal to the power transmitting device 10 satisfies the prevention conditions based on the prevention conditions represented by the prevention condition information 161 (step S100).

When the determination is made based on the first prevention condition CC1, the determining unit 151 performs the determination using the reception strength of the beacon signal. Specifically, the determining unit 151 determines whether the reception strength of the beacon signal received by the power transmitting device 10 is greater than a specified threshold. If the reception strength of the beacon signal is greater than the specified threshold, the distance between the power transmitting device 10 and the power receiving device 20 that has transmitted the beacon signal may be shorter than the specified distance. Also, if the reception strength of the beacon signal is less than or equal to the specified threshold, the distance between the power transmitting device 10 and the power receiving device 20 that has transmitted the beacon signal may be longer than or equal to the specified distance. When the reception strength of the beacon signal is greater than the specified threshold, the determining unit 151 determines that the power receiving device 20 that has transmitted the beacon signal satisfies the first prevention condition CC1.

When performing determination based on the second prevention condition CC2, the determining unit 151 obtains information representing received power at each power receiving device 20. In this case, the power transmitting device 10 transmits a power transfer signal to each of the power receiving devices 20 from which the beacon signals have been received, thereby supplying power to the power receiving devices 20. The antenna 21 of each power receiving device 20 receives the power transfer signal transmitted by the power transmitting device 10. The conversion unit 23 converts the power transfer signal received by the antenna 21 into direct-current power. The communication unit 22 of the power receiving device 20 transmits, to the power transmitting device 10, the magnitude of the direct-current power converted by the conversion unit 23 as information representing the received power. The determining unit 151 calculates the ratio of the supplied power to the received power based on the received information and the supplied power supplied from the power transmitting device 10 to the power receiving device 20. In the following description, the ratio of the supplied power to the received power is referred to as an efficiency ratio. When the calculated efficiency ratio is greater than a specified threshold, the determining unit 151 determines that the power receiving device 20 that has transmitted the beacon signal satisfies the second prevention condition CC2.

The power transmitting device 10 does not reduce power supply to the power receiving device 20 that has been determined not to satisfy the prevention conditions by the determining unit 151, and performs power supply in a normal mode (step S102). The power transmitting device 10 reduces power supply to the power receiving device 20 determined to satisfy the prevention conditions by the determining unit 151 (step S104).

[Operational Advantages of Embodiment]

The above-described embodiment has the following operational advantages.

(1) The determining unit 151 determines whether the power receiving device 20 that has transmitted a beacon signal satisfies the prevention conditions based on the prevention condition information 161, which represents the prevention conditions. When the prevention conditions are satisfied, the power received by the power receiving device 20 is prevented from increasing. Based on the determination result of the determining unit 151, the antenna 11, which is a power supplying unit, reduces the power supply to the power receiving device 20 that satisfies the prevention conditions.

With this configuration, the power transmitting device 10 prevents the power receiving device 20 that satisfies the prevention conditions from receiving excessive power.

(2) The antenna 11, which is a power supplying unit, includes an antenna array. When supplying power to the power receiving device 20 that satisfies the prevention conditions, the antenna 11 reduces power supply by reducing the number of antennas to be operated in the antenna array as compared to a case in which the antenna 11 supplies power to a power receiving device 20 that does not satisfy the prevention conditions.

With this configuration, the power transmitting device 10 is prevented from supplying excessive power to the power receiving devices 20, so that the power receiving devices 20 are prevented from receiving excessive power.

(3) The prevention conditions include the first prevention condition CC1, which represents a state in which the distance between the power transmitting device 10 and the power receiving device 20 that has transmitted a beacon signal is shorter than the specified distance. The determining unit 151 determines that the first prevention condition CC1 is satisfied if the distance between the power transmitting device 10 and the power receiving device 20 that has transmitted a beacon signal is shorter than the specified distance.

With this configuration, the power transmitting device 10 reduces power supply to the power receiving device 20 located at a short distance, so that the power receiving devices 20 are prevented from receiving excessive power.

(4) The prevention conditions include the second prevention condition CC2, which represents a state in which the efficiency ratio is greater than a specified threshold. The efficiency ratio refers to the ratio of the power supplied by the power transmitting device 10 to the power receiving device 20 that has transmitted a beacon signal to the power received by the power receiving device 20 that has transmitted the beacon signal. When the efficiency ratio is greater than the specified threshold, the determining unit 151 determines that the second prevention condition CC2 is satisfied.

With this configuration, the power transmitting device 10 is prevented from supplying power to the power receiving device 20 having an excessively high power supply efficiency, so that the power receiving devices 20 are prevented from receiving excessive power.

The above-described embodiment may be modified as follows. The above-described embodiment and the following modifications can be combined as long as the combined modifications remain technically consistent with each other.

In the example illustrated in FIG. 1, the number of the power receiving devices 20 included in the contactless power supply system 1 is two. However, the number of the power receiving devices 20 is not limited thereto. The contactless power supply system 1 may include one power receiving device 20 or more than two power receiving devices 20. An upper limit may be set for the number of the power receiving devices 20 included in the contactless power supply system 1. The upper limit of the number of the power receiving devices 20 may be determined in accordance with, for example, power that can be supplied by the power transmitting device 10 in the contactless power supply system 1.

In the above description, a case has been described in which the antenna 11, which is a power supplying unit, includes an antenna array, and the antenna 11 reduces the power supply by reducing the number of antennas to be operated in the antenna array. However, the present disclosure is not limited thereto. The antenna 11 may reduce the power supply in other manners. For example, when supplying power to the power receiving device 20 that satisfies the prevention conditions, the antenna 11 may supply power based on the power of one of a first power source and a second power source that has the lower remaining power capacity. As described above, the power source 17 includes, for example, a power conversion circuit that converts power supplied from grid-connected power into power that can be used in the power transmitting device 10. When the power receiving device 20 is supplied with the power of the power source 17, the power receiving device 20 continues being supplied with power since the remaining power capacity of the power source 17 generally does not run out or run low. In contrast, when the power receiving device 20 is supplied with the power of the battery 14, it is difficult to continuously supply power to the power receiving device 20 if the remaining power capacity of the battery 14 runs out or runs low. With this modification, the power transmitting device 10 is prevented from continuously supplying power to the power receiving devices 20 excessively, so that the power receiving devices 20 are prevented from receiving excessive power.

In addition, the conversion unit 13 may control the duty cycle or the phase shift of the power supplied from the power source so as to convert the power supplied to a power receiving device 20 satisfying the prevention conditions into power lower than the power supplied to a power receiving device 20 not satisfying the prevention conditions. The conversion unit 13 may be circuitry including: 1) one or more processors that operate according to a computer program (software); 2) one or more dedicated hardware circuits (application specific integrated circuits: ASIC) that execute at least part of various processes; or 3) a combination thereof. The antenna 11 supplies the power appropriately converted by the conversion unit 13 to the power receiving devices 20, thereby supplying low power to the power receiving device 20 satisfying the prevention conditions, so as to reduce the power supply. With this modification, the power transmitting device 10 supplies lower power to a power receiving device 20 that satisfies the prevention conditions, thereby preventing the power receiving devices 20 from receiving excessive power.

Further, the antenna 11 may reduce the power supply by intermittently supplying power to the power receiving device 20 that satisfies the prevention conditions, as compared to a case in which the antenna 11 supplies power to a power receiving device 20 that does not satisfy the prevention conditions. For example, the antenna 11 may continuously supply power to a power receiving device 20 that does not satisfy the prevention conditions, and while intermittently supplying power to a power receiving device 20 that satisfies the prevention conditions. With this modification, the power transmitting device 10 prevents the power receiving device 20 that satisfies the prevention conditions from receiving excessive power as compared to a case in which the power supply is performed continuously. Power may be intermittently supplied also to a power receiving device 20 that does not satisfy the prevention conditions. In this case, the antenna 11 supplies power to the power receiving device 20 that satisfies the prevention conditions in an intermittent mode in which the intermittence, during which power is not supplied, is longer than the intermittence for the power receiving device 20 that does not satisfy the prevention conditions. With this modification, the power transmitting device 10 supplies lower power to a power receiving device 20 that satisfies the prevention conditions, thereby preventing the power receiving devices 20 from receiving excessive power.

In a case in which the power supply is reduced by a method other than reducing the power supply by reducing the number of antennas to be operated in the antenna array, the antenna 11 may include a configuration other than an antenna array.

In the above-described embodiment, the antenna 11 uniformly reduces power supply to the power receiving devices 20 determined to satisfy the prevention conditions. However, the present disclosure is not limited thereto. The antenna 11 may change the degree of reduction in accordance with the state of the power receiving device 20 that satisfies the first prevention condition CC1. For example, the antenna 11 may reduce power supply when the distance between the power transmitting device 10 and the power receiving device 20 that has transmitted a beacon signal is shorter than a specified distance, and increase the degree of reduction as that distance decreases (as that the power receiving device 20 approaches the antenna 11). That is, for example, the antenna 11 sets the power supplied in a case in which the distance between the power transmitting device 10 and the power receiving device 20 is short to be lower than that in a case in which the distance is long. As described above, the power receiving device 20 may receive excessive power in a case in which the distance between the power transmitting device 10 and the power receiving device 20 is too short. With this modification, the power transmitting device 10 reduces, by a greater degree, power supply to a power receiving device 20 that is closer to the power transmitting device 10, so that the power receiving devices 20 are prevented from receiving excessive power.

In the above described embodiment, the determining unit 151 determines whether the first prevention condition CC1 is satisfied based on the reception strength of the beacon signal. However, the present disclosure is not limited to this. The determining unit 151 may determine whether the first prevention condition CC1 is satisfied based on the angle of arrival of the beacon signal and the directivity of the antenna 11. Specifically, the determining unit 151 determines that the first prevention condition CC1 is satisfied when the angle of arrival of the beacon signal agrees with the directivity of the antenna 11. As described above, the power receiving device 20 may receive excessive power, for example, in a case in which the direction in which the power transmitting device 10 supplies power agrees with the orientation of the power receiving device 20. With this modification, the power transmitting device 10 reduces power supply to the power receiving device 20 at which the angle of arrival of the beacon signal agrees with the directivity of the antenna 11, thereby preventing the power receiving devices 20 from receiving excessive power.

In the above-described embodiment, the antenna 11 reduces the power supply to the power receiving devices 20 that has been determined to satisfy the second prevention condition CC2 by the determining unit 151. However, the present disclosure is not limited thereto. When a state in which the determining unit 151 determines that the second prevention condition CC2 is satisfied continues for a specified time or longer, the antenna 11 may stop power supply to that power receiving device 20. In this case, the determining unit 151 further determines whether a state in which the power receiving device 20 satisfies the second prevention condition CC2 has continued for the specified time or longer. For example, when determining that the second prevention condition CC2 is satisfied, the determining unit 151 causes the storage unit 16 to store the identification information of the power receiving device 20 that satisfies the second prevention condition CC2 and a time stamp representing the date and time when it is determined that the second prevention condition CC2 is satisfied, while associating the identification information and the time stamp with each other. The determining unit 151 refers to the information stored in the storage unit 16 for the power receiving device 20 that is determined again to satisfy the second prevention condition CC2, and identifies the duration of the state in which the second prevention condition CC2 is satisfied based on the time stamp and the date and time at which the determination was made again.

The power receiving device 20 does not receive excessive power if the distance between the power transmitting device 10 and the power receiving device 20 is too short only temporarily or if the direction in which the power transmitting device 10 supplies power agrees with the orientation of the power receiving device 20 only temporary. In contrast, the power receiving devices 20 may receive excessive power if the distance between the power transmitting device 10 and the power receiving device 20 continues to be too short or if the direction in which the power transmitting device 10 supplies power continues to agree with the orientation of the power receiving device 20. With this modification, the power transmitting device 10 stops supplying power to the power receiving device 20 that has been in a state of a high power supply efficiency for the specified period of time or longer, thereby preventing the power receiving devices 20 from receiving excessive power.

The determining unit 151 may determine whether the prevention conditions are satisfied based on changes in the state of the power receiving devices 20. In this case, the prevention conditions include a third prevention condition CC3, which represents a state in which the power received most recently by the power receiving device 20 is greater, by an amount greater than a specified value, than the power that was received by the power receiving device 20 when the antenna 11 started supplying power. For example, while receiving power from the power transmitting device 10, the communication unit 22 transmits, to the power transmitting device 10, the magnitude of the DC power converted by the conversion unit 23 as information representing the received power at specified time intervals. The communication unit 12 stores the information representing the received power from the power receiving device 20 and the identification information of the power receiving device 20 in the storage unit 16, while associating these pieces of information with each other. The determining unit 151 refers to the information stored in the storage unit 16, compares the information representing a past value of the received power and the information representing the most recent received power for a certain power receiving device 20, and determines that the third prevention condition CC3 is satisfied if the value of the most recent received power is greater than the past value of the received power by an amount greater than the specified value. The information representing the past received power includes all pieces of information representing received power obtained during a period from the start of the power supply by the antenna 11 to the obtainment of the information representing the most recent received power. When the power supply is stopped by the antenna 11, the information related to the power receiving device 20 to which the power supply is stopped is cleared, among the pieces of information related to the past received power stored in the storage unit 16.

Even if the determining unit 151 once determines that the prevention conditions are not satisfied, the power receiving device 20 may be located at a position at which or in a direction in which the power receiving device 20 receives excessive power if the power transmitting device 10 or the power receiving device 20 is moved during power supply. With this modification, the power transmitting device 10 is prevented from supplying excessive power to the power receiving devices 20 even if the power transmitting device 10 or the power receiving devices 20 enter into a state in which the power supply efficiency is excessively high.

In the above-described embodiment, three prevention conditions, which are the first prevention condition CC1, the second prevention condition CC2, and the third prevention condition CC3, have been described. However, the present disclosure is not limited thereto. The number of prevention conditions included in the prevention condition information 161 may be one, two, or greater than three.

When there are multiple prevention conditions, an order of priority may be set for the prevention conditions. For example, the priority of the first prevention condition CC1 may be set higher than those of the second prevention condition CC2 and the third prevention condition CC3. In this case, the determining unit 151 determines that a power receiving device 20 that satisfies the prevention conditions if that power receiving device 20 has been determined to satisfy the first prevention condition CC1 regardless of whether the power receiving device 20 satisfies the second prevention condition CC2 and the third prevention condition CC3.

In the above-described embodiment, the determining unit 151 determines that a power receiving device 20 satisfies the prevention conditions if that power receiving device 20 satisfies any one of the first prevention condition CC1, the second prevention condition CC2, and the third prevention condition CC3. However, the present disclosure is not limited thereto. The determining unit 151 may determine that s a power receiving device 20 satisfies the prevention conditions if that power receiving device 20 satisfies all of the first prevention condition CC1, the second prevention condition CC2, and the third prevention condition CC3.

In the above-described embodiment, the antenna 11 and the antenna 21 are used in the communication related to power transfer signals, the communication related to beacon signals, and the information communication related to transmission and reception of various types of information. However, the present disclosure is not limited thereto. The power transmitting device 10 and the power receiving devices 20 may each include separate antennas respectively used for the communication related to power transfer signals, the communication related to beacon signals, and the information communication related to transmission and reception of various types of information. For example, when the information communication related to transmission and reception of various kinds of information is frequently performed between the power transmitting device 10 and the power receiving devices 20, the antenna 11 and the antennas 21 may fail to be properly used for the transmission and reception of power transfer signals or the transmission and reception of beacon signals. If the power transmitting device 10 and the power receiving devices 20 each include separate antennas used for the communication related to power transfer signals, the communication related to beacon signals, and the information communication related to transmission and reception of various types of information, each type of communication is prevented from being interfered with another type of communication.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

What is claimed is:

1. A contactless power supply system, comprising one or more power receiving devices, a power transmitting device, and a determining unit, wherein
each power receiving device includes:
a transmitting unit that is configured to transmit a beacon signal to the power transmitting device; and
a power receiving unit that is configured to receive power from the power transmitting device by contactless power supply,
the power transmitting device includes:
a receiving unit that is configured to receive the beacon signal from each power receiving device; and
a power supplying unit that is configured to supply power to the power receiving devices by contactless power supply,
the determining unit is configured to determine, based on a prevention condition information that represents a prevention condition, whether the power receiving device that has transmitted the beacon signal satisfies the prevention condition, the power received by the power receiving device being prevented from increasing when the prevention condition is satisfied, and
the power supplying unit is configured to reduce power supply to the power receiving device that satisfies the prevention condition based on a determination result of the determining unit.

2. The contactless power supply system according to claim 1, wherein
the power transmitting device includes a first power source and a second power source, and
the power supplying unit is configured to, when supplying power to the power receiving device that satisfies the prevention condition, supply power based on power of one of the first power source and the second power source that has a lower remaining power capacity.

3. The contactless power supply system according to claim 1, wherein
the power supplying unit includes an antenna array, and
the power supplying unit is configured to, when supplying power to the power receiving device that satisfies the prevention condition, reduce power supply by reducing the number of antennas to be operated in the antenna array as compared to a case in which the power supplying unit supplies power to the power receiving device that does not satisfy the prevention condition.

4. The contactless power supply system according to claim 1, wherein
the power transmitting device includes a conversion unit that is configured to convert power supplied from a power source,
the conversion unit is configured to control a duty cycle or a phase shift so as to convert the power supplied to the power receiving device that satisfies the prevention condition into power lower than power supplied to the power receiving device that does not satisfy the prevention condition, and
the power supplying unit is configured to supply the power converted by the conversion unit to the power receiving devices, thereby reducing the power supplied to the power receiving device that satisfies the prevention condition.

5. The contactless power supply system according to claim 1, wherein the power supplying unit is configured to reduce the power supply by intermittently supplying power to the power receiving device that satisfies the prevention condition, as compared to a case in which the power supplying unit supplies power to the power receiving device that does not satisfy the prevention condition.

6. The contactless power supply system according to claim 1, wherein
the prevention condition includes a condition that represents a state in which a distance between the power transmitting device and the power receiving device that has transmitted the beacon signal is shorter than a specified distance, and
the determining unit is configured to determine that the prevention condition is satisfied when the distance is shorter than the specified distance.

7. The contactless power supply system according to claim 6, wherein the power supplying unit is configured to reduce power supply by a greater degree as the distance decreases.

8. The contactless power supply system according to claim 1, wherein
the prevention condition includes a condition that represents a state in which a ratio of the power supplied by the power transmitting device to the power receiving device that has transmitted the beacon signal to the power received by the power receiving device that has transmitted the beacon signal is greater than a specified threshold, and
the determining unit is configured to, when the ratio is greater than the specified threshold, determine that the prevention condition is satisfied.

9. The contactless power supply system according to claim 8, wherein the power supplying unit is configured to, when a state in which the determining unit determines that the ratio is greater than the specified threshold continues for a specified time or longer, stop the power supply to the power receiving device that satisfies the prevention condition.

10. The contactless power supply system according to claim 1, wherein
the prevention condition includes a condition that represents a state in which the power received most recently by one of the power receiving devices is greater, by an amount greater than a specified value, than the power that was received by the one of the power receiving devices when the power supplying unit started supplying power, and
the determining unit is configured to determine that the prevention condition is satisfied when the power received most recently by one of the power receiving devices is greater than the specified value.

11. The contactless power supply system according to claim 1, wherein the power transmitting device includes the determining unit.
